(19) United States
(12) Patent Application Publication
(10) Pub. No.: US 2005/0182536 A1
(43) Pub. Date: Aug. 18, 2005

(54) Methods and apparatus for determining battery characteristics in a vehicle

(76) Inventors: Marquis D. Doyle, Clemmons, NC (US); John Robert Orrell JR., Advance, NC (US); Jeffrey Lee Day, Lexington, NC (US); Robert Bruce Stansell, Winston-Salem, NC (US)

Correspondence Address: Qualcomm Incorporated;Patents Department, 5775 Morehouse Drive, San Diego, CA, 92121-1714, US

(21) Appl. No.: 10/782,659

(22) Filed: Feb. 18, 2004

(51) Int. Cl. G06F 19/00

(52) U.S. Cl. 701/29; 340/455

(57) ABSTRACT

Methods and apparatus for determining battery characteristics in a vehicle. A method is provided for determining a potential failure of a battery in a vehicle. The method includes determining one or more battery characteristics during a vehicle starting event, and comparing the battery characteristics to stored reference parameters derived from one or more prior starting events. The method also includes activating a battery alert indicator that indicates a potential battery failure if a selected battery characteristic exceeds a selected reference parameter.

### BACKGROUND

I. Field

The present invention relates generally to transportation equipment, construction equipment, and delivery systems, and more particularly, to methods and apparatus for determining the battery characteristics of a battery in a vehicle to identify whether the battery poses a risk of failure.

II. Description of the Related Art

Advances in technology have provided for increased automation in many industries. For example, in the shipping industry, technology has allowed for the shipment and delivery of cargo virtually around the clock. Delivery vehicles now carry and deliver cargo to all parts of the country. For example, in the trucking industry, cargo-carrying tractor-trailers may be driven hundreds or thousands of miles to reach a delivery site. In some cases, the delivery vehicles may make many intermediate stops before reaching their final destinations.

Typically, on heavy trucks such as tractor-trailers, good condition batteries are required to reliably start the vehicle. As the battery weakens prior to complete failure, starting the vehicle engine may become more difficult, and if not attended to, may cause permanent damage to the engine starter or other vehicle components. When the battery finally fails to start the engine, a service call is required so that the battery can be replaced. If the battery failure occurs while the vehicle is in-route making deliveries, the in-route service call results in added costs, and the extra time needed to replace the battery may result in delivery delays.

One technique that has been used to address this problem is to schedule periodic maintenance of the vehicle. For example, maintenance personnel may inspect or service the vehicle at regular intervals. However, periodic maintenance of this type may fail to detect that the potential for battery failure exists. For example, the battery may seem fine during the inspection, but as the vehicle travels a long delivery route, the battery may be weakened enough so that it fails in-route. For example, the vehicle may travel through areas of the country that experience very cold weather, which can result in additional strain and stress on the battery causing an in-route failure. Thus, periodic inspections are not very effective in detecting this type of battery failure.

Therefore, what is needed is a system for use in a vehicle to identify a weak battery that poses a potential risk of failure, so that the battery may be replace before an expensive in-route battery failure occurs, thereby saving the costs associated with in-route vehicle service and avoiding potential delivery delays.

### SUMMARY

In one or more embodiments, a system comprising methods and apparatus is provided for use in a vehicle to accurately determine the vehicle's battery characteristics, and thereby identify a weak battery for timely service before an actual failure occurs.

In one embodiment, the system detects abnormal starting events that are indicative of a weak battery. For example, difficult engine starting is one indicator of a weak battery. In one embodiment, the battery voltage is monitored during a starting event and a battery waveform is recorded and analyzed for selected battery characteristics. For example, the battery waveform is analyzed for low voltage conditions, engine crank speed, engine crank time, and other battery characteristics. A low voltage condition is measured just after the starting event begins. The crank speed is derived from a battery voltage ripple caused by the individual cylinder compressions of the engine. The crank time is defined as the time it takes to start the engine.

In one embodiment, the battery waveform is analyzed and if it is determined that the battery poses a potential risk of failure, vehicle indicators are activated to alert the vehicle operator to the battery's condition. In another embodiment, vehicle information, such as the battery waveform, is transmitted to a remote diagnostic station where it is analyzed by service technicians who may also determine that the battery poses a risk of failure. The service personnel can then communicate the battery's condition to vehicle so that the operator is alerted to the potential problem.

In one or more embodiments, the system operates in-route and in real-time to determine a potential battery failure condition. The system determines the battery state at every starting event so that as the battery begins to fail, its condition can be detected before a total battery failure occurs. Thus, the system minimizes unplanned downtime due to in-route battery failure and reduces maintenance costs because potential battery failures are detected quickly before other vehicle components are damaged. In another embodiment, the system operates to use the detected battery characteristics to detect the potential failure of other vehicle components, such as the fuel system or electrical system.

In one embodiment, a method is provided for determining a potential failure of a battery in a vehicle. The method comprises determining one or more battery characteristics during a vehicle starting event, and comparing the battery characteristics to stored reference parameters derived from one or more prior starting events. The method also comprises activating a battery alert indicator that indicates a potential battery failure if a selected battery characteristic exceeds a selected reference parameter.

In another embodiment, apparatus is provided for determining a potential failure of a battery in a vehicle. The apparatus comprises logic to receive a battery signal during a vehicle starting event. The apparatus also comprises detection logic that operates to determine one or more battery characteristics from the battery signal. The detection logic also comprises logic to compare the battery characteristics to reference parameters derived from one or more prior starting events to determine whether the battery poses a potential risk of failure. The apparatus also comprises logic to activate one or more vehicle alert indicators if a selected battery characteristic exceeds a selected reference parameter.

In still another embodiment, apparatus is provided for determining a potential failure of a battery in a vehicle. The apparatus comprises means for determining one or more battery characteristics during a vehicle starting event, and means for comparing the battery characteristics to stored reference parameters derived from one or more prior starting events. The apparatus also comprises means for activating a battery alert indicator that indicates a potential battery failure if a selected battery characteristic exceeds a selected reference parameter.

In still another embodiment, a computer-readable media is provided that comprises instructions, which when executed by a processor, operate to determine a potential failure of a battery in a vehicle. The computer-readable media comprises instructions for determining one or more battery characteristics during a vehicle starting event, and instructions for comparing the battery characteristics to stored reference parameters derived from one or more prior starting events. The computer-readable media also comprises instructions for activating a battery alert indicator that indicates a potential battery failure if a selected battery characteristic exceeds a selected reference parameter

### BRIEF DESCRIPTION OF THE DRAWINGS

The foregoing aspects and the attendant advantages of the embodiments described herein will become more readily apparent by reference to the following detailed description when taken in conjunction with the accompanying drawings wherein:

FIG. 1 shows a delivery vehicle that includes one embodiment of a battery-state detection system;

FIG. 2 shows a detailed diagram of one embodiment of a battery-state detection system for use in a delivery vehicle;

FIG. 3 shows one embodiment of a battery waveform;

FIG. 4 shows one embodiment of a method for determining a potential battery failure for use with a battery-state detection system; and

FIG. 5 shows a table that illustrates one embodiment of reference parameters that may be used by a battery-state detection system to test the condition of a vehicle battery.

### DETAILED DESCRIPTION

The following detailed description describes methods and apparatus for providing a battery-state detection system to determine the battery characteristics of a battery in a vehicle. The battery characteristics are used to determine whether or not the battery poses a potential risk of failure. In one embodiment, the vehicle includes a wireless communication system that allows the detection system to communicate the detected battery characteristics through a communication channel to a remote diagnostic station. For example, in one embodiment, the detection system communicates through a satellite-based wireless communication channel to the diagnostic station. It should also be understood that the described detection system could also be used to detect the battery characteristics of a battery in virtually any type of vehicle including, but not limited to, trucks, buses, automobiles, construction equipment, and watercraft.

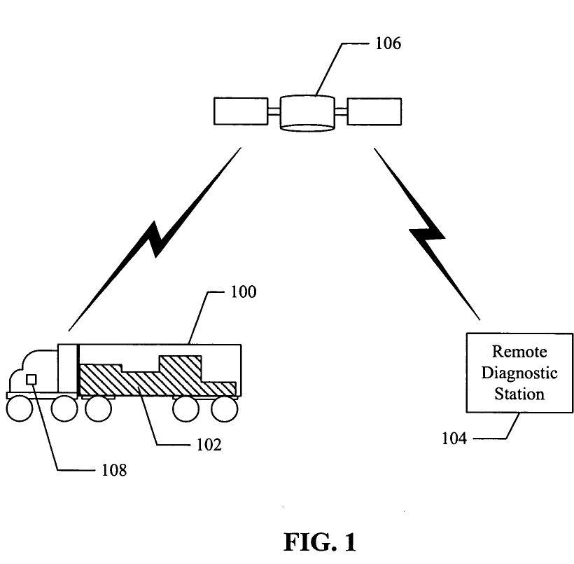

FIG. 1 shows a vehicle 100 that comprises one embodiment of a battery-state detection system 108. The vehicle 100 in this example comprises a tractor-trailer, commonly used in the long-haul trucking industry to transport goods from shippers to consignees. The vehicle 100 further comprises a mobile communication terminal (MCT, not shown) for communicating with one or more remote locations using a satellite-based wireless communication system and satellite 106. Generally, the MCT resides onboard a tractor portion of the vehicle 100 so as to be easily accessible by the vehicle operator. The trailer portion of the vehicle 100 includes cargo 102 to be delivery to one or more delivery sites.

The communication system provides two-way communication between the vehicle 100 and a remote diagnostic station 104. The communication system may also provide communication between the vehicle 100 and third parties, such as a fleet management center or dispatch center, family members, governmental authorities, consignees, shippers, and so on. The vehicle 100 may also comprise other wireless systems that could be used in addition or in the alternative to the satellite system, such as an analog or a digital cellular telephone system, an RF communication system, or a wireless data communication network, such as a cellular digital packet data (CDPD) network.

In one embodiment, the detection system 108 operates to detect the battery characteristics of an engine battery used by the vehicle 100. The system 108 analyzes the detected battery characteristics and determines whether or not a potential for battery failure exists. For example, the system 108 determines if the battery is losing its capacity to start or otherwise operate the vehicle 100. If the system 108 determines that a potential for battery failure exists, the system 108 displays one or more warning messages to the vehicle operator, so that battery service can be scheduled before the battery weakens enough to disable the vehicle while in-route.

In one embodiment, the detection system 108 communicates the detected battery information to the on-board MCT, which relays the information to the remote diagnostic station 104 using the wireless communication system. The remote diagnostic station 104 comprises equipment and personnel that can further process the information received from the detection system 108. For example, the diagnostic station 104 may perform additional tests or analysis on the received information to predict more accurately the potential for battery failure. The received information may also be stored as part of an operation and maintenance record for the vehicle 100.

In one embodiment, the remote station 104 communicates information to the detection system 108 using the wireless communication system. For example, if a weak battery is detected as a result of testing performed at the remote station 104, diagnostic messages are transmitted to the vehicle 100 from the diagnostic station 104, which cause the detection system 108 to activate vehicle-warning indicators that indicate a weak battery condition to the vehicle operator. In another embodiment, the diagnostic station 104 transmits reference parameters to the detection system 108 using the wireless communication system. For example, the reference parameters are used by the detection system 108 to perform tests on the engine battery to determine its condition. The reference parameters may be designed to account for the vehicle's condition, location, weather conditions, or any other criteria. For example, prior to the vehicle 100 beginning its delivery route, a set of reference parameters is transmitted to the detection system 108 from the diagnostic station 104. The reference parameters are used by the detection system 108 to test the condition of the engine battery as the vehicle proceeds along its delivery route. For example, in one embodiment, as the vehicle travels from a warm region of the country to a colder region, the detection system 108 uses the ambient temperature to select which of the reference parameters to use to test the condition of the engine battery.

As a result, the detection system 108 operates to minimize the chance of an in-route battery failure, and thereby saves the costs associated with in-route service calls and cargo delivery delays.

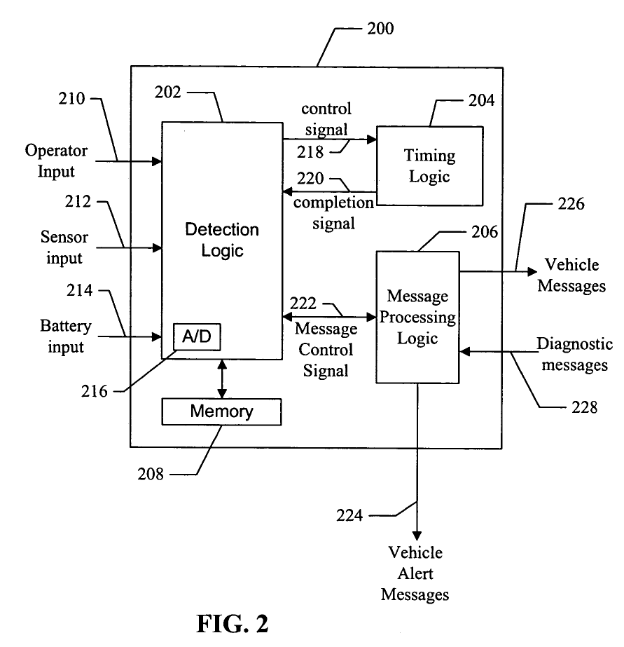

FIG. 2 shows a detailed diagram of one embodiment of a battery-state detection system 200 for use in a delivery vehicle. The detection system 200 comprises detection logic 202, timing logic 204, message processing logic 206, and memory 208.

It should be understood that the elements shown in FIG. 2 are for illustrative purposes only, and that implementation of the detection system 200 could be achieved in one of any number of ways using greater or fewer functional elements. For example, the detection logic 202, timing logic 204, and message processing logic 206 could all be implemented in a computer program executed by one or more processors.

The detection logic 202 may comprise a processor, CPU, gate array, logic, discreet circuitry, software, or any combination of hardware and software. The detection logic 202 includes input logic to receive various operator inputs 210 and sensor inputs 212. For example, the operator inputs 210 comprise inputs from the vehicle operator that are entered via an operator keypad or other input device. The sensor inputs 212 are signals derived from one or more vehicle sensors, such as an engine temperature sensor, ambient temperature sensor, ignition system sensor, and any other sensor that may be located on the vehicle and/or its cargo. The detection logic 202 also comprises logic to receive an engine battery voltage signal 214 that can be measured directly or derived from a sensor coupled to measure the engine battery output voltage. In one embodiment, the detection logic 202 comprises an analog-to-digital (A/D) converter 216 that receives the battery signal 214 as input and converts this signal to a battery voltage waveform that is processed by the detection system 200.

The timing logic 204 may comprise a processor, CPU, gate array, logic, discreet circuitry, software, or any combination of hardware and software. The timing logic 204 operates to measure selected time intervals under the control of the detection logic 202. For example, the detection logic 202 provides a control signal 218 to the timing logic 204 to control the operation of the timing logic 204 to measure a selected time interval. In one embodiment, the control signal 218 includes control information that operates to clear, preset, reset, activate, stop, suspend, or otherwise control the operation of the timing logic 204. The timing logic 204 provides a completion signal 220 to the detection logic 202 that includes a time value for the time interval that has been measured.

The message processing logic 206 may comprise a processor, CPU, gate array, hardware logic and/or discreet circuitry, software, and/or any combination of hardware and software. The message processing logic 206 is coupled to the detection logic 202 to receive a message control signal 222. The message processing logic 206 operates to generate messages used during operation of the detection system 200. One function of the message processing logic 206 is to generate vehicle alert messages 224 that are used to provide vehicle alerts to the vehicle operator. For example, in one embodiment, the vehicle alert message interface to the vehicle's control systems to cause an alarm to sound, lights to flash, or to activate any other indicator to alert the vehicle operator to the detected vehicle conditions. In one embodiment, the message processing logic 206 generates a vehicle alert message 224 to alert the vehicle operator regarding the weakened condition of the engine battery. Thus, the operator can respond by scheduling vehicle service to replace the battery.

Another function of the message processing logic 206 is to generate vehicle messages 226 that are input to an on-board wireless communication system for transmission to a remote diagnostic station. For example, the message processing logic 206 may transmit any information detected or processed by the detection system 200 to the remote diagnostic station. This information includes, but is not limited to, sensor input readings, battery sensor input, battery voltage waveform, or any other information that is available to the detection system 200.

In one embodiment, messages output from the message processing logic 206 are pre-stored in memory 208 and are sent to the message processing logic 206 via the message control signal 222. In another embodiment, the message processing logic 206 assembles specific messages from real-time information sent in the message control signal 222, such as the current time, sensor readings, or operator inputs. Thus, the message processing logic 206 may use virtually any combination of stored and real-time information to generate the various vehicle messages 226 that are transmitted to the remote diagnostic station.

The message processing logic 206 also comprises logic to receive diagnostic messages 228 that have been received at the vehicle from the wireless communication system. For example, the messages 228 may be received from the remote diagnostic station. In one embodiment, the messages 228 comprise reference parameters received from the remote diagnostic station that are to be used by the detection system 200. For example, the reference parameters may be used to evaluate the engine battery in different climate conditions. The diagnostic messages 228 are received by the message processing logic 206 and sent to the detection logic 202 as part of the message control signal 222. In one embodiment, parameters received from a remote diagnostic station are sent to the detection logic 202 for storage in the memory 208. Thus, the parameters can be retrieved as needed to perform various battery and other vehicle tests.

During operation of the detection system 200, the detection logic 202 determines one or more battery characteristics by processing the sensor inputs 212 and the battery signal input 214. In one embodiment, the detection logic 202 evaluates a battery voltage waveform produced by the A/D 216 when the operator starts the vehicle. For example, the operator starts the vehicle by turning on the vehicle's ignition system, which can be detected by an ignition sensor that provides a signal at the sensor input 212. During a starting event, the engine's battery is used to “crank” the engine to allow the engine to “start.” A battery sensor that is coupled to sense the battery output voltage provides a battery voltage signal on the battery input 214. The A/D 216 converts the battery voltage signal to a battery waveform that may also be referred to as a “crank” waveform.

The detection logic 202 analyzes one or more characteristics of the battery waveform to determine the condition of the battery. For example, the detection logic 202 operates to analyze battery characteristics, such as battery voltage dip, the speed that the starter can spin the engine, referred to as “crank speed,” and the length of time it takes to start the engine, which is referred to as “crank time.” Any suitable technique or process may be used by the detection logic 202 to determine and analyze the various battery characteristics. The detection logic 202 may also determine additional battery characteristics, such as the number of times the operator attempts to start the engine before the engine actually starts, which may be referred to as ‘start attempts.”

The system 200 may include any type of sensor to measure the operation of the battery, engine, vehicle, or environment, and information from those sensors may be provided to the detection logic 202, (i.e., via the sensor input 212). For example, the engine temperature and the outside ambient temperature may be measured and this information is input to the detection logic 202 and used to determine battery characteristics.

Once the detection logic 202 determines one or more characteristics of the battery, the detection logic 202 compares those characteristics to reference parameters that are stored in the memory 208 to determine the condition of the battery. For example, in one embodiment, the reference parameters may be derived from information collected during one or more prior engine starts. In another embodiment, the reference parameters may be downloaded to the system 200 from a remote diagnostic station, such as station 104 in FIG. 1. The diagnostic station uses the wireless communication system to download the reference parameters to the system 200 via the diagnostic message input 228 of the message processing logic 206.

If the detection logic 202 determines that the battery's condition poses a risk of failure, the detection logic 202 controls the message processing logic 206 to output one or more vehicle alert messages 224. For example, in one embodiment, the alert message 224 interface directly to control local indicators, alarms, lights, horns or other visual or audible indicators that provide an indication to the vehicle operator that the battery is in need of service. In one embodiment, the alert messages 224 interface with existing vehicle control systems, such as a vehicle data bus, to control various vehicle indicators to alert the vehicle operator about the state of the battery.

In one embodiment, in response to determining that the battery's condition poses a potential risk of failure, the detection logic 202 sends a selected message control signal 222 that causes the message processing logic 206 to generate one or more vehicle messages 226 that are transmitted to the remote diagnostic station via communication logic (i.e., MCT) located in the delivery vehicle. In one embodiment, the vehicle messages 226 alert the personnel at the remote diagnostic station that the battery's condition poses a risk of failure. In another embodiment, the vehicle messages include various data and other information processed by the system 200. For example, the vehicle messages may include battery, engine, vehicle, or cargo sensor information, as well as processed data, such as the battery waveform. Thus, the remote diagnostic station will receive battery status information and data that may be analyzed to determine the state of the battery.

In one embodiment, the system operates to determine the potential for failure of other vehicle components. For example, once the detection logic 202 determines one or more characteristics of the battery, these characteristics may be used to verify the operation of other vehicle components. For example, the battery voltage and engine crank speed may be determined to be within the desired tolerances, but the duration of the starting event or the number of start attempts may exceed the desired tolerances. Thus, it may be determined that a problem exists with the vehicle's fuel system or electrical system. As a result, a warning indicator may be activated to alert the vehicle operator to have the vehicle serviced before an in-route failure occurs. Thus, the system operates to detect both potential battery failures and potential failures with other vehicle components or systems.

In one or more embodiments, the detection logic 202 comprises logic to execute instructions to perform the functions described herein. For example, the instructions may be stored on a floppy disk, CDROM, magnetic tape, flash memory card, or any other memory device and downloaded into the detection system 200 for execution by the detection logic 202. Thus, any type of computer readable media may comprise program instructions, data or other information that when executed by the detection system 200 provides the functions described herein.

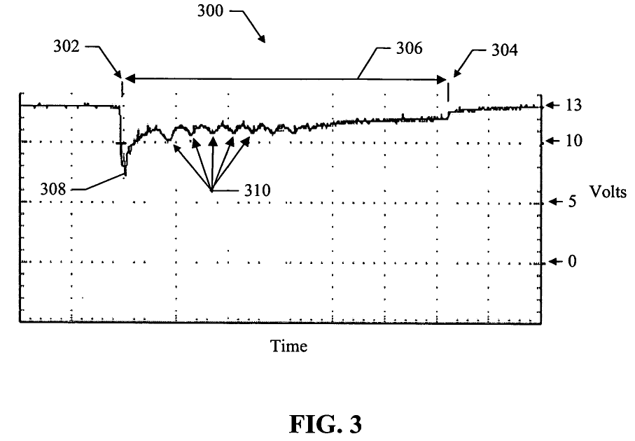

FIG. 3 shows one embodiment of a battery waveform 300 that is processed by one embodiment of a battery-state detection system. The battery waveform 300 illustrates a battery voltage waveform that may be output from the A/D 216 during an engine-starting event. The waveform 300 shows the engine battery voltage beginning with the activation of the vehicle's starter, as shown at 302, and completes with the starting of the vehicle engine, as shown at 304.

The battery voltage with the engine off is at a nominal voltage value. After the engine starter is activated (302), the battery voltage experiences an initial voltage dip, as shown at 308, where the battery voltage dips below 10 volts. As the battery voltage begins to recover, the voltage undergoes smaller dips 310 that occur in conjunction with the compression of the engine's cylinders. As the engine begins to start, the battery voltage slowly increases to its nominal value, as shown at the completion of the start cycle (304). By analyzing the waveform 300, the detection logic 202 is able to determine the initial battery dip 308, the timing of the smaller dips 310 that can be used to determine the engine crank speed, and the overall duration of the starting event, as shown at 306. Thus, the processing logic is able to determine several key battery characteristics that indicate the strength or weakness of the battery and the potential for battery failure. For example, a very low voltage dip 308, a very slow crank speed 310, or a very long duration of the starting event 306 indicate that the battery may be losing its starting capacity, and therefore, poses a potential risk of failure.

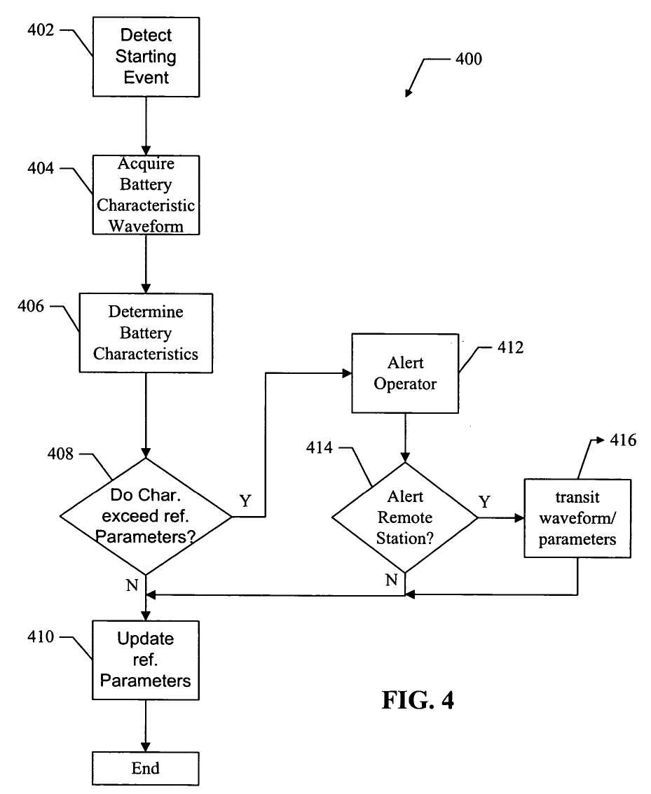

FIG. 4 shows one embodiment of a method 400 for determining a potential battery failure for use with a battery-state detection system. For example, the method 400 is suitable for use to operate one embodiment of a battery-state detection system described herein. For the following description, it will be assumed that a battery-state detection system is installed in a tractor portion of a delivery vehicle that is carrying cargo to be delivered to one or more delivery sites. For example, the delivery vehicle may be a tractor-trailer truck carrying a cargo of shipping containers to be delivered to one or more locations along a delivery route. Furthermore, it is assumed that the delivery vehicle includes a wireless communication system to communicate with a remote diagnostic station.

At block 402, the method begins when a starting event is detected. For example, the operator input 210 or the sensor input 212 is used by the detection logic 202 to determine when the operator has activated the ignition in an attempt to start the vehicle.

At block 404, a battery characteristic waveform is acquired. For example, the A/D 216 receives the battery signal 214 and converts it to a battery waveform. For example, the battery waveform may comprise a waveform as illustrated in FIG. 3.

At block 406, characteristics of the vehicle's battery are determined. For example, in one embodiment, the battery waveform acquired at block 404 is analyzed by the detection logic 202 to determine various battery characteristics. For example, the battery voltage dip (308), engine crank speed (310) or the duration of the starting event (306) may be determined.

In one embodiment, the detection logic 202 analyzes the battery waveform by using the timing logic 204 to measure various waveform characteristics. For example, the timing logic 204 is controlled by the detection logic 202 to measure the duration of the starting event 306, or engine crank speed 310. For example, the detection logic 202 activates the timing logic 204 via the control signal 218 to measure one or more battery characteristics. The timing logic 204 returns a value for the measured time interval to the detection logic 202 via the completion signal 220.

At block 408, a test is performed to determine if the measured battery characteristics exceed selected reference parameters. For example, the reference parameters may be stored in the memory 208. The reference parameters may be parameters that are based on the type of vehicle, type of battery, or based on battery characteristics measured during one or more prior starting events. The reference parameters may also be based on other factors, such as engine temperature, ambient temperature, or any other factors. For example, as the vehicle is driven from warm climates to cold climates, a different set of reference parameters are used (based on the ambient temperature) to test the battery's condition. In one embodiment, the reference parameters are downloaded to the detection system from a remote diagnostic station via the wireless communication system.

The detection logic 202 operates to compare the measured battery characteristics with the stored reference parameters. If the measured characteristics are within, or do not exceed selected tolerances based on the reference parameters, then the battery is determined to be in good condition and not posing a risk of possible in-route failure. The method then proceeds to block 410.

If the measured characteristics are not within, or exceed selected tolerances based on the reference parameters, then the battery is considered to pose a potential risk of in-route failure and the method proceeds to block 412. For example, in one embodiment, if a measured characteristic exceeds a 10% tolerance of the corresponding reference parameter, then the battery is considered to pose a risk of failure. Any tolerance values can be used to determine the battery's state and the associated risk of failure.

In one or more embodiments, it is also possible to operate the detection system to detect potential problems with other vehicle components. For example, the state of engine components such as the fuel filter, alternator, starter and other engine components may be determined by operation of the detection system. In this case, the reference parameters are designed to determine the state of these components, so that selected vehicle sensors can be evaluated and compared to the redesigned reference parameters to determine the potential risk of failure for these other vehicle components.

At block 412, the vehicle operator is alerted to the fact that the detection system has determined that the battery poses a potential risk for failure. For example, the detection logic 202 controls the message processing logic 206 to output one or more vehicle alert messages 224 that cause one or more vehicle alerts to be activated, thereby alerting the vehicle operator to the battery's condition.

At block 414, the remote diagnostic station is alerted to the fact that the battery has been determined to be at risk for failure. For example, the detection logic 202 controls the message processing logic 206 to output one or more vehicle messages 226 that are transmitted to the remote diagnostic station via the vehicle's wireless communication system, thereby alerting personnel at the remote station to the battery's condition.

At block 416, in an optional step, information is exchanged between the detection system and the remote diagnostic station. For example, the detection logic 202 may control the message processing logic 206 to transmit battery information, such as the battery waveform, to the remote station. In response, the remote station may transmit new reference parameters that are to be used to determine the battery's condition. In one embodiment, the remote station may analyze the battery waveform to determine that the battery poses a risk of failure even though the detection logic 202 did not determine the same conclusion. The remote station may transmit commands to the detection logic 202 which causes the detection logic 202 to control the message processing logic 206 to output one or more vehicle alert messages 224. Thus, the remote station may cause local vehicle alerts to be activated based on an analysis of the battery waveform performed at the remote station.

At block 410, new reference parameters are saved. For example, in one embodiment, the recently measured battery characteristics are saved as part of an average parameter set that may be used to test the battery during the next starting event. In another embodiment, parameters downloaded from the remote station at block 416 may be saved and used to test the battery's condition during the next starting event. In one embodiment, the parameters are saved in the memory 208.

The method 400 is intended to be illustrative and not limiting of the operation of the various embodiments described herein. For example, it would be obvious to one with skill in the art to make minor changes, additions or deletions to any of the described method steps. Furthermore, the described method steps may be combined, rearranged or reordered without deviating from the scope of the described embodiments.

In one or more other embodiments, the system operates to determine the potential for failure of other vehicle components. For example, in one embodiment, analysis of the battery waveform is used to detect whether a problem exists with one or more engine components. For example, during a starting event, if the battery voltage and engine crank speed are determined to be within the desired tolerances, but the duration of the starting event or the number of start attempts exceed the desired tolerances, then it may be determined that a problem exists with other engine components. For example, the vehicle's fuel system or electrical system may be malfunctioning, and as a result, the out of tolerance parameters have been detected. In this case, a warning indicator may be activated to alert the vehicle operator to have the vehicle serviced before and in-route failure occurs. Thus, the system operates to detect both potential battery failures and potential failures with other vehicle components or systems.

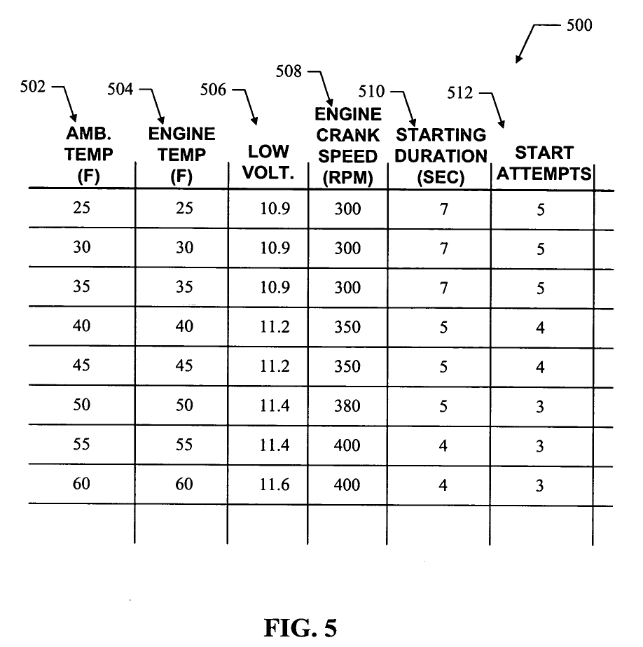

FIG. 5 show a table 500 that illustrates one embodiment of reference parameters that may be used by a battery-state detection system to test the condition of a vehicle battery. In one embodiment, the reference parameters 500 include data relating to the ambient 502 and engine 504 temperatures. This allows different sets of reference parameters to be used to test the vehicle's battery or other components based on the ambient or engine temperatures. The parameters in the table 500 also comprise a low voltage parameter 506, engine crank speed parameter 508, starting duration parameter 510, and engine start attempts 512.

The table 500 represents only a partial list of parameters that may to used to determine the condition of the vehicle battery or other components. It is also possible to incorporate any other available parameter as part of the table 500 for use in one or more of the described embodiments.

A system for detecting the state of a battery in a vehicle has been described that operates to determine whether the vehicle's battery poses a risk of in-route failure. Accordingly, while one or more embodiments of the detection system have been illustrated and described herein, it will be appreciated that various changes can be made to the embodiments without departing from their spirit or essential characteristics. Therefore, the disclosures and descriptions herein are intended to be illustrative, but not limiting, of the scope of the invention, which is set forth in the following claims.

1. A method for determining a potential failure of a battery in a vehicle, the method comprising:
determining one or more battery characteristics during a vehicle starting event;
comparing the battery characteristics to stored reference parameters derived from one or more prior starting events; and
activating a battery alert indicator that indicates a potential battery failure if a selected battery characteristic exceeds a selected reference parameter.

2. The method of claim 1, wherein the step of determining further comprises evaluating a battery waveform to determine the battery characteristics.

3. The method of claim 1, wherein the battery characteristics comprise one or more of a battery dip voltage, engine crank speed indicator, and engine starting time indicator.

4. The method of claim 1, wherein the step of comparing further comprises averaging battery characteristics from one or more prior starting events to determine the reference parameters.

5. The method of claim 1, wherein the step of comparing further comprises downloading the reference parameters from a remote station.

6. The method of claim 1, wherein the step of comparing further comprises selecting the reference parameters from a table of parameters based on one or more selection criteria, wherein the selection criteria comprise engine temperature, ambient temperature, battery type, and vehicle type.

7. The method of claim 1, further comprising transmitting the battery characteristics to a remote station using a wireless communication system.

8. The method of claim 1, further comprising transmitting a battery alert indicator to a remote station if a selected battery characteristic exceeds a selected reference parameter, wherein the battery alert indicator indicates a potential battery failure.

9. The method of claim 1, further comprising comparing the battery characteristics to the stored reference parameters to determine a potential vehicle component failure.

10. Apparatus for determining a potential failure of a battery in a vehicle, the apparatus comprising:
logic to receive a battery signal during a vehicle starting event;
detection logic that operates to determine one or more battery characteristics from the battery signal, and wherein the detection logic further comprises logic to compare the battery characteristics to reference parameters derived from one or more prior starting events to determine whether the battery poses a potential risk of failure; and
logic to activate one or more vehicle alert indicators if a selected battery characteristic exceeds a selected reference parameter.

11. The apparatus of claim 10, further comprising logic to create a battery waveform from the battery signal and evaluate the battery waveform to determine the battery characteristics.

12. The apparatus of claim 10, wherein the battery characteristics comprise one or more of a battery dip voltage, engine speed indicator, and engine starting time indicator.

13. The apparatus of claim 10, further comprising logic to average battery characteristics from one or more prior starting events to determine the reference parameters.

14. The apparatus of claim 19, further comprising logic to download the reference parameters from a remote station.

15. The apparatus of claim 10, further comprising logic to select the reference parameters from a table of parameters based on one or more selection criteria, wherein the selection criteria comprise engine temperature, ambient temperature, battery type, and vehicle type.

16. The apparatus of claim 10, further comprising logic to transmit the battery characteristics to a remote station using a wireless communication system.

17. The apparatus of claim 10, further comprising logic to transmit a battery alert indicator to a remote station if a selected battery characteristic exceeds a selected reference parameter, wherein the battery alert indicator indicates a potential battery failure.

18. The apparatus of claim 10, further comprising logic to compare the battery characteristics to the stored reference parameters to determine a potential vehicle component failure.

19. Apparatus for determining a potential failure of a battery in a vehicle, the apparatus comprising:
means for determining one or more battery characteristics during a vehicle starting event;
means for comparing the battery characteristics to stored reference parameters derived from one or more prior starting events; and
means for activating a battery alert indicator that indicates a potential battery failure if a selected battery characteristic exceeds a selected reference parameter.

20. The apparatus of claim 19, wherein the means for determining further comprises means for evaluating a battery waveform to determine the battery characteristics.

21. The apparatus of claim 19, wherein the battery characteristics comprise one or more of a battery dip voltage, engine crank speed indicator, and engine starting time indicator.

22. The apparatus of claim 19, wherein the means for comparing further comprises means for averaging battery characteristics from one or more prior starting events to determine the reference parameters.

23. The apparatus of claim 19, wherein the means for comparing further comprises means for downloading the reference parameters from a remote station.

24. The apparatus of claim 19, wherein the means for comparing further comprises means for selecting the reference parameters from a table of parameters based on one or more selection criteria, wherein the selection criteria comprise engine temperature, ambient temperature, battery type, and vehicle type.

25. The apparatus of claim 19, further comprising means for transmitting the battery characteristics to a remote station using a wireless communication system.

26. The apparatus of claim 19, further comprising means for transmitting a battery alert indicator to a remote station if a selected battery characteristic exceeds a selected reference parameter, wherein the battery alert indicator indicates a potential battery failure.

27. The apparatus of claim 19, further comprising means for comparing the battery characteristics to the stored reference parameters to determine a potential vehicle component failure.

28. A computer-readable media comprising instructions, which when executed by a processor, operate to determine a potential failure of a battery in a vehicle, the computer-readable media comprising:
instructions for determining one or more battery characteristics during a vehicle starting event;
instructions for comparing the battery characteristics to stored reference parameters derived from one or more prior starting events; and
instructions for activating a battery alert indicator that indicates a potential battery failure if a selected battery characteristic exceeds a selected reference parameter.

29. The computer-readable media of claim 28, further comprising instructions for comparing the battery characteristics to the stored reference parameters to determine a potential vehicle component failure.
